(19) United States
(12) Patent Application Publication
(10) Pub. No.: US 2019/0078734 A1
(43) Pub. Date: Mar. 14, 2019

(54) Tank Arrangement

(71) Applicant: WÄRTSILÄ FINLAND OY, Vaasa (FI)

(72) Inventor: Sören KARLSSON, Solf (FI)

(73) Assignee: WÄRTSILÄ FINLAND OY, Vaasa (FI)

(21) Appl. No.: 16/185,575

(22) Filed: Nov. 9, 2018

Related U.S. Application Data
(63) Continuation of application No. PCT/FI2016/050304, filed on May 10, 2016.

(51) Int. Cl. F17C 3/02; F17C 3/04

(52) U.S. Cl. CPC F17C 3/025; F17C 3/04; F17C 2201/0152; F17C 2201/035; F17C 2270/0105; F17C 2221/033; F17C 2223/0161; F17C 2227/0135; F17C 2260/011; F17C 2203/0643

(57) ABSTRACT

An exemplary tank arrangement for storing liquefied natural gas includes a multilobe tank having a gas-tight shell, wherein the arrangement includes a gas-tight and heat-insulated partition wall arranged within the shell for dividing the tank into a gas storage space, which is configured to hold liquefied natural gas, and a tank connection space, which is configured to enclose tank connections and valves associated with them.

### RELATED APPLICATION

This application claims priority as a continuation application under 35 U.S.C. § 120 to PCT/FI2016/050304, which was filed as an International Application on May 10, 2016, designating the U.S., the entire content of which is hereby incorporated by reference in its entirety.

### FIELD

The present disclosure relates to a tank arrangement for storing liquefied natural gas.

### BACKGROUND INFORMATION

Natural gas, and mixtures of hydrocarbons that are volatile enough to make the mixture appear in gaseous form in room temperature, can constitute an advantageous alternative to fuel oil as the fuel of internal combustion engines. In sea-going vessels that use natural gas as fuel, the natural gas can be stored onboard in liquid form, giving rise to the commonly used acronym LNG (Liquefied Natural Gas). Natural gas can be kept in liquid form by maintaining its temperature below a boiling point, which is approximately −162 degrees centigrade. LNG can be stored at a pressure that is close to the atmospheric pressure, but large tanks used for storing LNG need to withstand significant hydrostatic pressures and a certain overpressure. For achieving good mechanical strength, LNG tanks can be constructed as cylindrical or spherical containers. However, for practical reasons, large LNG tanks are sometimes designed as bilobe or multilobe tanks instead of cylindrical tanks. A bilobe tank includes two mating curved halves, for instance two spherical caps or two cylindrical segments. A multilobe tank includes at least three curved sections that are joined to each other. The sections can be partial cylinders or spheres.

For using the LNG as an energy source for internal combustion engines, various pieces of equipment are used in connection with LNG tanks. Tank connections for connecting an LNG tank to the equipment used for processing the LNG and the valves associated with them are arranged in a gas-tight tank connection space. The purpose of the tank connection space is to prevent the gas that may leak from the tank connections or the valves to enter a tank hold, in which the tank is located. For safety reasons, the tank connection space is connected to the LNG tank with double wall pipes.

### SUMMARY

A tank arrangement is disclosed for storing liquefied natural gas, the arrangement comprising: a multilobe tank having a gas-tight shell; and a gas-tight and heat-insulated partition wall arranged within the shell for dividing the tank into a gas storage space, which is configured to hold liquefied natural gas, and into a gas-tight tank connection space, which is configured to enclose an evaporator for vaporizing liquefied gas and/or low-pressure pumps and tank connections and valves associated with them.

### BRIEF DESCRIPTION OF THE DRAWINGS

Other features and advantages of the present disclosure will be appreciated from exemplary embodiments as disclosed herein with reference to the accompanying drawings, in which:

FIG. 1 shows a cross-sectional view of an exemplary ship having an exemplary tank arrangement according to an embodiment of the disclosure;

FIG. 2 shows a top view of the exemplary tank arrangement of FIG. 1; and

FIG. 3 shows a side view of the exemplary tank arrangement.

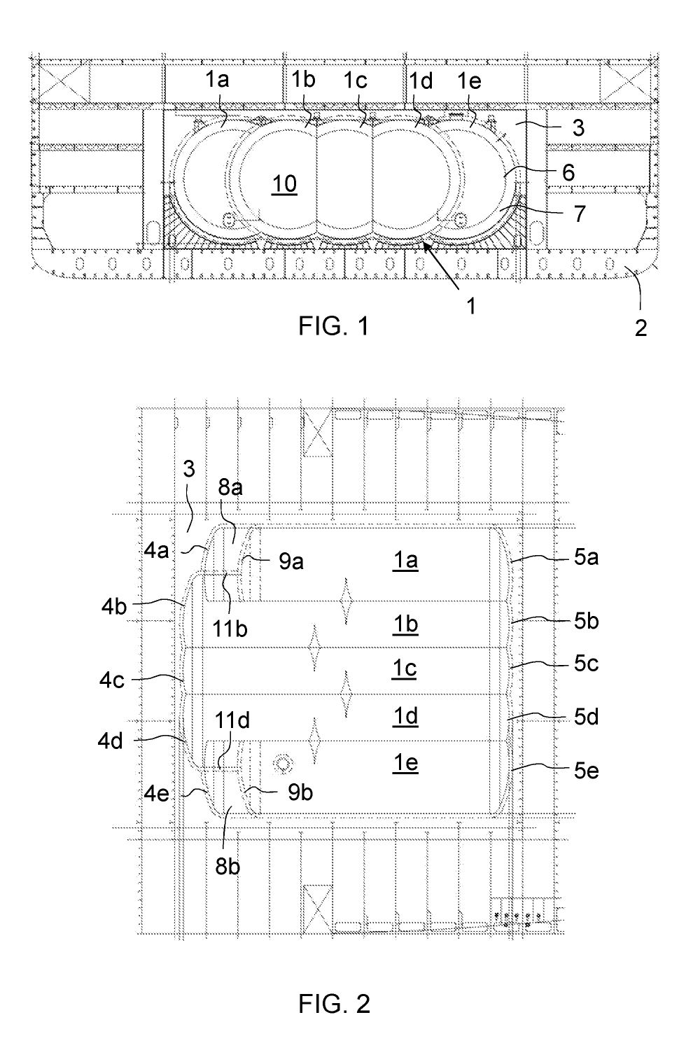

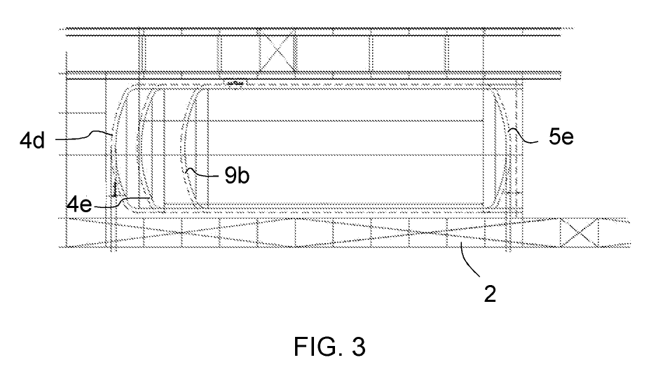

### DETAILED DESCRIPTION

An improved tank arrangement for storing liquefied natural gas is disclosed.

The tank arrangement according to the present disclosure includes a multilobe tank having a gas-tight shell, wherein the arrangement includes a gas-tight and heat-insulated partition wall, which is arranged within the shell for dividing the tank into a gas storage space, which is configured to hold liquefied natural gas and a tank connection space, which is configured to enclose tank connections and valves associated with them.

In an exemplary tank arrangement according to the present disclosure, the tank connection space is integrated to the multilobe tank. The tank connection space is delimited by the gas-tight shell of the tank and double-wall pipes are thus not needed between the tank connection space and the gas storage space. The tank arrangement forms a compact structure, which is suitable for example for use in ships.

According to an exemplary embodiment of the present disclosure, the partition wall includes at least one layer made of a cold resistant material. The material can be, for instance, stainless steel. Cold resistant material needs to be used at least in the parts that are exposed to low temperatures.

According to an exemplary embodiment of the present disclosure, the tank has a single-shell structure including a shell made of a cold resistant material and a heat insulation layer arranged on the outer surface of the shell.

According to an exemplary embodiment of the present disclosure, the arrangement includes a second partition wall for separating a second tank connection space from the gas storage space. The second tank connection space can accommodate similar equipment as the other tank connection space.

According to an exemplary embodiment of the present disclosure, a tank connection space includes at least one pump for pumping gas that is stored in the tank.

According to an exemplary embodiment of the present disclosure, the tank includes at least three tank sections that are shaped as segments of cylinders. The longitudinal axis of the cylinders can be horizontal and the sections can be arranged in a row in a horizontal plane and a tank connection space can be arranged in an outermost tank section.

According to an exemplary embodiment of the present disclosure, the tank connection space is delimited by an end of the tank section.

According to an exemplary embodiment of the present disclosure, the tank connection space is further delimited by a cylindrical wall of an adjacent tank section.

A sea-going vessel according to the present disclosure includes a tank arrangement defined above.

The Figures show an exemplary LNG tank 1 that is arranged in a ship 2. The exemplary LNG tank 1 is a container that is configured to store liquefied natural gas. Natural gas is kept in liquid form by maintaining its temperature below a boiling point, which is approximately −162 degrees centigrade. The LNG tank 1 is located in a tank hold 3, which is located around the longitudinal center line of the ship 2. The LNG tank 1 stores liquefied gas that is used as fuel in one or more engines of the ship 2.

The LNG tank 1 can have a single shell structure. The space holding the LNG is formed by a shell 6 that is made of a cold resistant material. The expression “cold resistant material” refers to a material that can withstand the temperature of liquefied natural gas. Minimum design temperature of the material should, for example, be at most −165° C. The material can be, for instance, stainless steel. Suitable materials are, for instance, 9% nickel steel, low manganese steel, austenitic steels, such as types 304, 304L, 316, 316L, 321 and 347 and austenitic Fe—Ni alloy (36% nickel). An insulation layer 7 is arranged around the shell 6. The insulation layer 7 can be made of, for instance, polyurethane.

The LNG tank 1 can be a multilobe tank. The expression “multilobe tank” refers here to a tank that includes at least three tank sections that have a curved cross-sectional profile and which are joined to each other such that the shell 6 of the tank 1 has an undulating shape at least on two sides. In the exemplary embodiment of the Figures, the LNG tank 1 includes five tank sections 1a, 1b, 1c, 1d, 1e each having the shape of a partial cylinder. The longitudinal center lines of the tank sections 1a, 1b, 1c, 1 d, 1e are parallel to each other. The centermost tank section 1c can have a shape that is formed by cutting a segment from a horizontal cylinder by two vertical planes. The other tank sections 1a, 1 b, 1d, 1e can each have a shape that is formed by cutting a segment from a horizontal cylinder by one vertical plane.

The exemplary sections 1a, 1b, 1c, 1d, 1e of the tank 1 are arranged in a row in a horizontal plane. The outermost tank sections 1a, 1e are shorter than the three sections 1b, 1c, 1d in the middle of the LNG tank 1. The ends of the tank sections 1a, 1b, 1c, 1d, 1 e are closed by end caps 4a, 4b, 4c, 4d, 4e, 5a, 5b, 5c, 5d, 5e. The end caps can have a shape of a spherical cap or part of a spherical cap.

For delivering LNG from the LNG tank 1 to engines of the ship 2 and for processing the gas, for instance by vaporizing it, the ship 2 can be provided with different kinds of equipment. For accommodating tank connections and valves associated with them, the ship 2 can include at least one tank connection space 8a, 8b. A tank connection space 8a, 8b can also accommodate other equipment, such as an evaporator for vaporizing the liquefied gas and/or low-pressure pumps. For instance, a tank connection space 8a, 8b can accommodate a pump that is used for discharging LNG from the tank 1. The tank connection space 8a, 8b forms a gas-tight space. The tank connection space 8 is therefore also considered a secondary barrier in case there should be leakage of the LNG. The purpose of the tank connection space 8a, 8b is to prevent a gas that may leak from the tank connections or the valves to enter the tank hold 3.

In accordance with exemplary embodiments of the disclosure, the tank connection space 8a, 8b is formed within the space delimited by the shell 6 of the LNG tank 1. In this way, a compact structure is formed and the pipes between the tank connection space 8a, 8b and the space storing the liquefied gas do not need to be double-wall pipes.

In the exemplary embodiments of the Figures, a tank arrangement includes a first tank connection space 8a and a second tank connection space 8b. The arrangement includes a first partition wall 9a, which divides the tank 1 into a gas storage space 10 and a first tank connection space 8a. A second partition wall 9b separates the second tank connection space 8b from the gas storage space 10. The partition walls 9a, 9b are gas-tight and heat-insulated. The partition walls 8a, 8b are made of a cold resistant material. The partition walls 8a, 8b can be made of the same material as the shell 6 of the tank 1. The partition walls 9a, 9b can thus be made of suitable stainless steel and insulated with polyurethane. The partition walls 9a, 9b could also have a double-wall structure, where vacuum is arranged between two shell layers. At least the shell layer facing the gas storage space 10 can be made of a cold resistant material, such as stainless steel that can withstand the cold temperatures of the tank 1.

In the exemplary embodiments of the Figures, the tank connection spaces 8a, 8b can be arranged in the outermost sections 1a, 1e of the tank 1. Since the outermost tank sections 1a, 1e are slightly shorter than the other tank sections 1b, 1c, 1d and the outermost tank sections 1a, 1e do not extend in the longitudinal direction of the tank 1 to the level of the other tank sections 1b, 1c, 1d at the end where the tank connections spaces 8a, 8b are arranged, there is room in the tank hold 3 for pipes protruding from the tank connection spaces 8a, 8b. Each tank connection space 8a, 8b also can include a manhole, which is arranged in an end cap 4a, 4e of the respective section 1a, 1e of the tank 1.

In the exemplary embodiment of the Figures, each partition wall 9a, 9b is formed as a spherical cap, which is arranged at a distance from an end cap 4a, 4e of the respective section 1a, 1e of the tank 1. The partition walls 9a, 9b are parallel to the ends 4a, 4e of the respective tank sections 1a, 1e. A cylindrical wall 11b, 11d of an adjacent tank section 1b, 1d is joined to the spherical cap to delimit the tank connection space 8a, 8b.

It will be appreciated by a person skilled in the art that the invention is not limited to the embodiments described above, but may vary within the scope of the appended claims.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

1. A tank arrangement for storing liquefied natural gas, the arrangement comprising:
a multilobe tank having a gas-tight shell; and
a gas-tight and heat-insulated partition wall arranged within the shell for dividing the tank into a gas storage space, which is configured to hold liquefied natural gas, and into a gas-tight tank connection space, which is configured to enclose an evaporator for vaporizing liquefied gas and/or low-pressure pumps and tank connections and valves associated with them.

2. A tank arrangement according to claim 1, wherein the partition wall comprises:
a layer made of a cold resistant material.

3. A tank arrangement according to claim 1, wherein the partition wall comprises:
a layer made of stainless steel.

4. A tank arrangement according to claim 1, wherein the tank has a single-shell structure comprising:
a shell made of a cold resistant material; and
a heat insulation layer arranged on an outer surface of the shell.

5. A tank arrangement according to claim 1, comprising:
a second partition wall for separating a second tank connection space from the gas storage space.

6. A tank arrangement according to claim 1, wherein the tank connection space comprises:
at least one pump for pumping gas that is stored in the tank.

7. A tank arrangement according to claim 1, wherein the tank comprises:
at least three tank sections that are shaped as segments of cylinders.

8. A tank arrangement according to claim 7, wherein longitudinal axes of the cylinders are horizontal and the tank sections are arranged in a row in a horizontal plane and the tank connection space is arranged in an outermost tank section.

9. A tank arrangement according to claim 8, wherein the tank connection space is delimited by an end of the tank section.

10. A tank arrangement according to claim 9, wherein the tank connection space is further delimited by a cylindrical wall of an adjacent tank section.

11. A tank arrangement according to claim 1, in combination with a sea-going vessel, the combination comprising:
a vessel hull containing the tank arrangement.

12. A tank arrangement according to claim 2, wherein the partition wall comprises:
a layer made of stainless steel.

13. A tank arrangement according to claim 12, wherein the tank has a single-shell structure comprising:
a shell made of a cold resistant material; and
a heat insulation layer arranged on an outer surface of the shell.

14. A tank arrangement according to claim 13, comprising:
a second partition wall for separating a second tank connection space from the gas storage space.

15. A tank arrangement according to claim 14, wherein the tank connection space comprises:
at least one pump for pumping gas that is stored in the tank.

16. A tank arrangement according to claim 15, wherein the tank comprises:
at least three tank sections that are shaped as segments of cylinders.

17. A tank arrangement according to claim 16, wherein longitudinal axes of the cylinders are horizontal and the tank sections are arranged in a row in a horizontal plane and the tank connection space is arranged in an outermost tank section.

18. A tank arrangement according to claim 17, in combination with a sea-going vessel, the combination comprising:
a vessel hull containing the tank arrangement.
